(19) United States
(12) Patent Application Publication
(10) Pub. No.: US 2020/0019077 A1
(43) Pub. Date: Jan. 16, 2020

(54) Media Adapted for Both Direct Thermal Recording and Memjet-Type Printing

(71) Applicant: Appvion Operations, Inc., Appleton, WI (US)

(72) Inventors: Fadi S. Chakar, Neenah, WI (US); Dylan M. Schnese, Menasha, WI (US); Sydney N. Smead, Greenville, SC (US); Teri L. Brancich, Neenah, WI (US)

(73) Assignee: Appvion Operations, Inc., Appleton, WI (US)

(21) Appl. No.: 16/032,982

(22) Filed: Jul. 11, 2018

(51) Int. Cl. G03G 9/113; C09D 11/328; G03G 9/087; B41J 2/315; B41J 2/01

(52) U.S. Cl. CPC G03G 9/1131; C09D 11/328; B41J 2/01; B41J 2/315; G03G 9/08742

(57) ABSTRACT

Dual functionality recording media are disclosed. The recording media or materials can impart information both by direct thermal printing, and by being receptive to a modified inkjet printing technology known in the art as Memjet™ printing, which combines microelectromechanical systems (MEMS) and inkjet technology. The recording materials include a base substrate to which several coatings are applied. The coatings are selected to provide both direct thermal functionality and receptivity to Memjet-type dye-based inks as applied in Memjet-type printing systems. Heat-sensitive recording capability is provided by a leuco dye/acidic developer combination. Receptivity to Memjet-type dye-based printing is provided by a topcoat of suitable composition. The present inventors recognized that Memjet-type inks printed onto the topcoat suffer from a graying problem, but the problem is solved by appropriate selection of the leuco dye/acidic developer combination.

### FIELD OF THE INVENTION

The present invention relates to recording media including but not limited to coated paper substrates, and in particular, to recording media that are adapted for direct thermal recording by incorporating a leuco dye/acidic developer combination, and are also adapted for printing thereon by a modified inkjet technique characterized in the art by the term “Memjet”, as in Memjet™ inks and Memjet™ printing machines. The invention also pertains to related methods, systems, and articles.

### BACKGROUND OF THE INVENTION

In direct thermal recording, an image is produced by selectively heating the recording material or medium at selected locations by passing the material under or otherwise across a thermal print head. The recording material includes a coating of a thermally responsive layer, and the image is provided by a heat-induced change in color of the thermally responsive layer. Some common uses of direct thermal recording may include, without limitation, cash register receipts, labels, and event tickets. Direct thermal recording media are also sometimes referred to as coated thermochromic paper, thermal paper, thermal recording material, thermally-responsive record material, and similar terms.

Numerous types of direct thermal recording media are known. See, for example, U.S. Pat. No. 3,539,375 (Baum); U.S. Pat. No. 3,674,535 (Blose et al.); U.S. Pat. No. 3,746,675 (Blose et al.); U.S. Pat. No. 4,151,7.48 (Baum); U.S. Pat. No. 4,181,771 (Hans on et al,); U.S. Pat. No. 4,246,318 (Baum); and U.S. Pat. No. 4,470,057 (Glanz). In these cases, basic colorless or lightly colored chromogenic material, such as a leuco dye and an acidic color developer material, are contained in a coating on a substrate. When heated to a suitable temperature by a thermal print head, the coating melts or softens to permit the materials to react, thereby producing a colored mark or image at the heated location. Thermally-responsive record materials thus have a characteristic thermal response, desirably producing a colored image of sufficient intensity or contrast upon selective thermal exposure.

Inkjet printing technology is also known. In contrast to direct thermal recording techniques, inkjet printing is accomplished by depositing a material—namely, one or more inkjet inks—onto the outer major surface of the substrate. Inkjet printing creates an image on the substrate by propelling droplets of liquid ink onto the surface in a pattern that produces the desired image. FIG. 1A schematically illustrates a conventional inkjet printing system 110a. In this system 110a, an image is formed on the outer surface of a suitable substrate 120a, such as an A4-size piece of coated paper. Reservoirs (not shown) of cyan, magenta, yellow, and black inks are typically provided on a print head 112a, which is mounted close to the substrate 120a. The print head 112a directs droplets of these inks in individual jets towards the substrate 120a in a controlled pattern, within the confines of a small spray zone 114a. Coverage over the entire top surface of the substrate is achieved by moving the print head 112a relative to the substrate 120a by the coordinated actions of sliding the print head 112a back and forth along a transverse mounting member 113, and advancing the substrate in discrete steps indicated by arrows 116a, so that the spray zone 114a traces out a path similar to path 118. In this way, a full color image can be printed on the entire top surface of the substrate 120a.

A printing technology that combines inkjet techniques with microelectromechanical systems (MEMS) is marketed under the name “Memjet” by Memjet Technology Ltd. of Dublin, Ireland, and has been available in the marketplace since 2010. Memjet printing can arguably be considered to fall within the broad category of inkjet printing, insofar as Memjet printing is accomplished by spraying liquid inks onto the surface of a substrate in directed jets via small nozzles. However, differences between Memjet printing and other types of inkjet printing, such as that of FIG. 1A, are large enough that a practical distinction must be made. The differences are due to differences in how the ink is applied to the substrate, but also extend to differences in the formulations and related properties of the inks themselves that are used in the two distinctive methods. A printing system 110b that uses the Memjet printing technique is shown schematically in FIG. 1B.

Similar to FIG, 1A, the Memjet-like printing system 110b of FIG. 1B operates by spraying droplets of ink onto a substrate 120b, which may for example be an A4-size piece of coated paper similar to substrate 120a. But unlike FIG. 1A, the Memjet system 110b uses a print head 112b whose spray zone 114b spans the entire width of the substrate, such that an image that covers the entire top surface of the substrate 120b can be made in a single pass of the substrate under the print head, in a continuous motion along the longitudinal or machine direction indicated by arrow 110.

According to Memjet Technology Ltd., the foundation of its VersaPass™ Memjet™ printing system is a 70,400-nozzle thermal inkjet print head. The print head allows the full width of an A4 sheet of paper to be imaged (printed) in a single pass under the print head, however, the print head can also be used with other substrate sizes, as well as continuous webs of substrate material such as roll goods, where images can be printed on a given side of the substrate in a single pass.

The VersaPass™ print head is said to have five independent ink channels, each channel being made up of two linear nozzle arrays, spaced at 800 nozzles per inch (npi) and offset from one another by 1/1600 inch, for an effective spacing of 1600 npi. per ink channel. This provides a print width (print head active length) of 8.77 inches (222.8 mm), and a total print zone width (print head active width) of 0.72 mm. The ten nozzle rows (two for each of the five ink channels) achieve the five-channel 1600 npi architecture, for a native print resolution of 1600 dots per inch (dpi). If print widths larger than 8.77 inches are desired, multiple such print heads can be arranged end-to-end lengthwise. The VersaPass™ Memjet™ inks used with this print head have compositions that are confidential, however, they are said to be aqueous dye-based, comprised of ˜70% water, with no hazardous air pollutants (HAPs), no Substances of Very High Concern per REACH (SVHCs), and no toxic metals as regulated by the Restriction of Hazardous Substances directive (RoHS). These inks are also said to include humectants, surfactants, and specialty additives. The inks are ejected from the nozzles of the print head at a drop size of 1.2 picoliters, and at print speeds ranging from 6 to 136.2 inches per second (ips) depending on the desired print resolution along the length of the paper.

For purposes of this document, terms such as “Memjet-type printing”, “MT printing”, “MEMS/inkjet printing”, and the like refer to printing techniques, procedures, or steps that can be carried out using, or that are otherwise in substantially accordance with, (1) print heads and dye-based inks substantially as described in the three immediately preceding paragraphs, or (2) print heads and dye-based inks marketed under the brand “Memjet” on or before Jul. 1, 2018.

In addition to yielding vibrant and lasting colors, the Memjet™ printing technology offers printing at high speeds, low run cost, and improved environmental friendliness because of its water-based inks as compared to UV inks, solvent inks, etc., and to other printing materials such as HP™ Indigo™ liquid toners.

### SUMMARY OF THE INVENTION

No recording material currently available is both receptive to Memjet-type dye-based printing and at the same time provides variable information on demand such as that obtained from a thermally responsive recording material. Stated differently, we are aware of no direct thermal recording product available in the marketplace that is also compatible with Memjet-type printing technology.

Attempting to develop such a dual functionality product can easily lead to performance issues such as unacceptable smearing of the Memjet-type inks, and other problems. If a standard thermally responsive recording material (which includes a conventional topcoat) is simply fed into a Memjet-type printer, the water-based Memjet-type inks do not anchor to the exposed surface of the topcoat, and are easily smeared. We have discovered that attempts to solve this smearing problem by replacing the conventional topcoat with a topcoat whose composition is otherwise considered to be Memjet-compatible can lead, surprisingly, to unacceptable discoloration of the printed Memjet-type ink.

A need therefore exists in the industry for alternative direct thermal recording media. Accordingly, we have developed a new family of dual functionality recording media. The recording media or materials can impart information both by direct thermal recording, and by being receptive to Memjet-type dye-based printing. The recording materials include a base substrate to which several coatings are applied. The coatings are selected to provide both direct thermal functionality, and receptivity to Memjet-type dye-based inks as applied in Memjet-type printing systems. Heat-sensitive recording capability is provided by a leuco dye/acidic developer combination in a thermally responsive layer. Receptivity to Memjet-type dye-based printing is provided by a topcoat of suitable composition. We have found that a discoloration or graying problem of Memjet-type inks printed onto the topcoat can be avoided or solved by appropriate selection of the leuco dye/acidic developer combination in the underlying thermally responsive layer.

We therefore disclose herein, among other things, recording materials that include a substrate, and a thermally responsive layer and a topcoat carried by the substrate. The thermally responsive layer is disposed between the substrate and the topcoat, and the topcoat is receptive to Memjet-type dye-based printing. The thermally responsive layer includes a leuco dye and a developer, and at least one of the leuco dye and the developer is selected to substantially avoid graying of ink applied to the topcoat by Memjet-type dye-based printing.

The recording material may further include a thermal insulating layer disposed between the substrate and the thermally responsive layer. The topcoat may contact the thermally responsive layer, the thermally responsive layer may contact the thermal insulating layer, and the thermal insulating layer may contacts the substrate. The thermally responsive layer may be substantially isocyanate-free. The developer may be non-phenolic or mono-phenolic. The developer may be non-phenolic, and may comprise 4,4′-DDS or 3,3′-DDS or Pergafast 201 (discussed further below). The developer may be mono-phenolic and may comprise D8 or BPS-MBE (discussed further below). The developer may be bis-phenolic, and may comprise 4,4′-BPS or TGSH (discussed further below), and the leuco dye may comprise ETAC (discussed further below). The topcoat may include a filler, a binder, and a fixative. The tiller may include at least one of precipitated silica, fumed silica, hydrated alumina, fumed alumina, and aluminum trihydroxide (ATH). The binder may comprise PVOH. The fixative may comprise a polyamine solution polymer.

The topcoat may not he receptive to at least sonic inkjet-type printing. The substrate may comprise one or more of an absorbent paper stock, polypropylene, polyethylene, or polyethylene terephthalate. The thermally responsive layer and the topcoat may be substantially coextensive with the substrate. Alternatively, one or both of the thermally responsive layer and the topcoat may not be coextensive with the substrate, such that some locations on the substrate are devoid of the thermally responsive layer, or of the topcoat, or of both.

We also disclose herein recording materials that include a substrate, and a thermal insulating layer, a thermally responsive layer, and a topcoat carried by the substrate. The thermally responsive layer is disposed between the thermal insulating layer and the topcoat, and the thermal insulating layer is disposed between the substrate and the thermally responsive layer. The topcoat is receptive to Memjet-type dye-based printing. The thermally responsive layer includes a leuco dye and a developer; and (a) the developer is non-phenolic, or (b) the developer is mono-phenolic, or (c) the developer is bis-phenolic and the leuco dye comprises ETAC, such that (d) graying of Memjet-type dye-based inks printed onto the topcoat is substantially avoided.

The thermally responsive layer may be substantially isocyanate-free. The topcoat may comprise a filler, a binder, and a fixative. The topcoat may not be receptive to at least some inkjet-type printing.

Numerous related methods, systems, and articles are also disclosed.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The inventive articles, systems, and methods are described in further detail with reference to the accompanying drawings, of which:

FIG. 1A is a schematic top or plan view of a conventional inkjet printing system;

FIG. 1B is a schematic top or plan view of a conventional Memjet-like printing system;

FIGS. 2A-2D are schematic perspective views of a dual functionality recording material, with FIG. 2A showing the material after manufacture but before printing or imaging of any kind, FIG. 2B shows the material after only Memjet-type printing, FIG. 2C shows the material after only direct thermal recording or imaging, and FIG. 2D shows the material after both Memjet-type printing and direct thermal recording; and

FIG. 3 is a schematic side or sectional view of a dual functionality recording material.

In the figures, like reference numerals designate like elements.

### DETAILED DESCRIPTION OF ILLUSTRATIVE EMBODIMENTS

As mentioned above, we have developed a new family of dual functionality recording media or materials that can impart information both by direct thermal recording and by being receptive to Memjet-type dye-based printing, with no substantial graying, darkening, or similar discoloration of the Memjet-type inks applied to the surface. The recording materials include a base substrate to which several coatings are applied. The coatings are selected to provide both direct thermal functionality and receptivity to Memjet-type dye-based inks as applied in Memjet-type printing systems. Heat-sensitive recording capability is provided by a leuco dye/acidic developer combination in a thermally responsive layer. Receptivity to Memjet-type dye-based printing is provided by a topcoat of suitable composition. Discoloration or graying of Memjet-type inks printed onto the topcoat is avoided by appropriate selection of the leuco dye/acidic developer combination in the underlying thermally responsive layer.

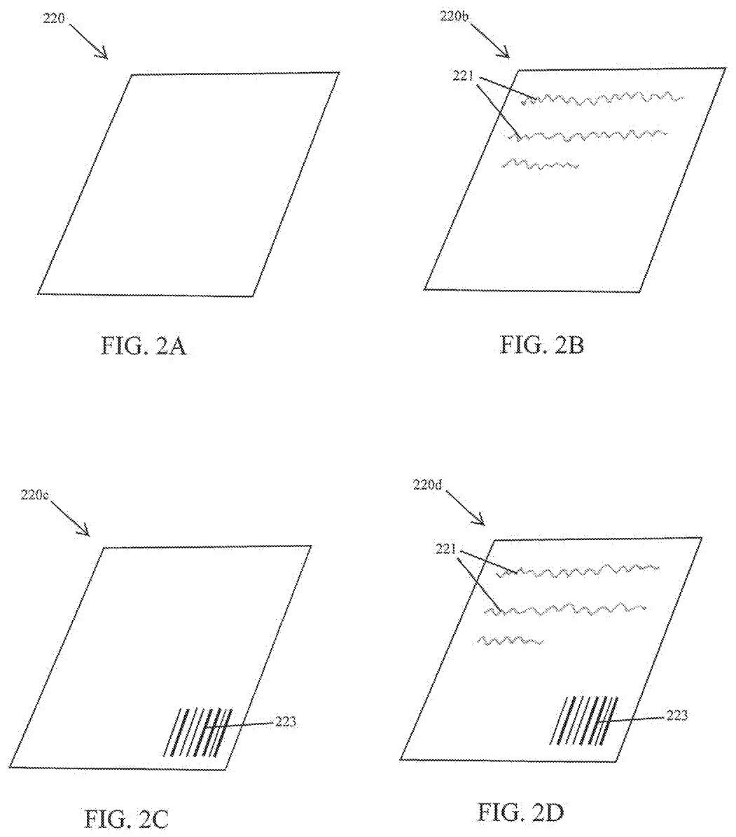

Schematic illustrations of such a dual functionality recording material are provided in FIGS. 2A-2D. FIG. 2A shows the material 220 in its fully manufactured state, but before printing or imaging of any kind. In that condition it may have a uniform color and appearance, typically a uniformly White color.

FIG. 2B shows the same recording material but after being printed on by Memjet-type printing. One or more Memjet-type dye-based inks, applied to the exposed outer surface of the recording material using a Memjet-type printer, produce an ink-based image 221. The recording material is receptive to the Memjet-type printing insofar as the dye-based inks, upon being applied to the surface, do not substantially smear, run, blur, bleed, or discolor. Thus a sharp, clear image is obtained with full and vibrant color(s) and no substantial discoloration. The image 221 is shown only schematically in the figure, but it may be any desired image and may include one or more of alphanumeric characters, graphics, and other indicia. The ink-based image 221 is typically colorful, i.e., it typically includes colors other than just black or gray, such as red, green, yellow, or blue, or other non-gray or non-black colors capable of being formed by combinations of cyan, magenta, and yellow inks. The ink-based image 221 may reside on any portion or portions of the outer major surface of the recording material, and may cover a large part or a small part of that outer surface. The printed recording material of FIG. 2B is identified with reference number 220b to distinguish it from the unprinted material 220.

FIG. 2C shows the recording material of FIG. 2A but after being imaged by direct thermal recording, e.g. by applying heat to selected portions of the surface of the recording material with a conventional thermal print head (which contacts the recording material during the recording process), or with a non-contact thermal imaging device or system that delivers heat or energy to such selected portions of the surface. The selected heating causes a permanent localized color change in a thermally responsive coating of the recording material, which is perceived by end-users as a thermal image 223. The image 223 is shown schematically in the figure as a bar code, but it may be any desired image and may include one or more of alphanumeric characters, graphics, and other indicia. The thermal image 223 is typically monochromatic, e.g. black or gray, but in some cases it can have a non-black and non-gray monochromatic color. Thermal images 223 that have more than one color, i.e., different colors at different positions, are also known (e.g, wherein the different colors are produced by different amounts of heat or energy delivered to the recording material at the different positions), and can be used with the disclosed embodiments. The thermal image 223 does not reside as a separate material atop the recording material, but exists as colored portion(s) of an existing coating, which coating may extend across the entire length and width of the recording material. The coating may instead be present only at selected locations of the recording material, such as when it is made by spot-coating. The image 223 may occupy any portion or portions of the recording material, e.g. as seen in a plan view, and may cover a large part or a small part of the overall transverse dimensions of the recording material. The imaged recording material of FIG. 2C is identified with reference number 220c to distinguish it from the unprinted material 220 and from the printed recording material 220b.

FIG. 2D shows the dual functionality recording material after being subjected to both Memjet-type printing and direct thermal recording. One or more Memjet-type dye-based inks, applied to the exposed outer surface of the recording material using a Memjet-type printer, produce an ink-based image 221. Selectively heating the recording material with a thermal print head causes a permanent localized color change in a thermally responsive coating of the material, which is manifested as a thermal image 223. The ink-based image 221 and the thermal image 223 may be the same as or similar to those discussed above in connection with FIGS. 2B and 2C (respectively), the details of which need not be repeated. The images 221, 223 can be fanned in any order, e.g., the ink-based image 221 can be formed before the thermal image 223, or vice versa, or the images can be formed at the same or overlapping time periods with different print heads. The images 221, 223 are preferably formed such that they do not substantially overlap spatially on a given side of the recording material, when seen in plan view. The images 221, 223 may for example be formed such that at any given position on a given side of the recording material, if a Memjet-type ink resides on the surface then no thermally-induced color change is present in the underlying thermally responsive coating, and if there is a thermally-induced color change in the thermally responsive coating then no Memjet-type ink is present on the surface. In alternative embodiments, the images 221, 223 may overlap partially, e.g. such that at some locations both images are present while at other locations the image 221 is present without the image 223, and/or vice versa.

The disclosed recording materials are suitable for use in diverse applications that can benefit from a combination of ink-based images and direct thermal-based variable information images, such as, without limitation, labeling, facsimile, point of sale (POS) printing, tags, tickets, and pressure sensitive labels. A recording material having the combination of properties shown schematically in FIGS. 2A-2D desirably provides increased functionality and flexibility in imaging design choices, and flexibility in how users may choose to apply the different types of images. In one of many possible scenarios, a first user may subject a non-imaged recording material to Memjet-type printing to produce a roll, spool, or batch of vibrantly colored labels, tickets, or other documents. This colorfully printed recording material could then be sold or shipped to second user who is equipped with a direct thermal printer. The second user may then use the thermal printer to thermally record additional information, e.g., print-on-demand information (also known as variable information) such as an expiration date, series number, bar code (1D or 2D), customer code, or the like, or other images, marks, or indicia, onto the vibrantly printed document, e.g., in a small area or window of the document reserved for such purpose and not printed with ink. The finished document would thus contain, on the same side of the document, both image(s) printed with Memjet-type inks, and image(s) provided by direct thermal recording. One or both of the first and second users may of course employ additional converting steps such as varnishing, laminating, perforating, or slitting, and may add one or more security features to the recording material such as foils, chips, or ribbons.

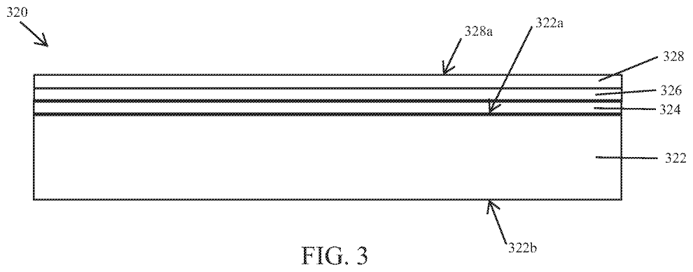

A schematic side or sectional view of a representative dual functionality recording material is shown in FIG. 3. In the figure, the recording material 320 is made by applying several different coatings to one side or major surface 322a of a substrate 322. Briefly, the substrate 322 is coated to carry a thermal insulating layer 324, a thermally responsive layer 326, and a topcoat 328. The coatings are preferably applied in the order shown, with the layer 326 located between the layers 324, 328, and with the layer 324 located between the layer 326 and the substrate 322. In some cases, however, the thermal insulating layer 324 may be omitted. The coatings can be formed by any suitable coating technique, including roll coating, knife coating, rod coating, gravure coating, curtain coating, spot coating, and so forth. Furthermore, additional layers and coatings can be added to or included with the recording material on its front and/or back side, provided the receptivity to Memjet-type inks is maintained. For example, one or more coatings can be applied to the opposite side of the substrate, i.e., to the major surface 322b. These elements of the dual functionality recording material 320 will now be described in more detail.

The substrate 322 can be any material onto which the other layers can be coated or applied, and then carried. The kind or type of substrate material is not critical. Generally the substrate 322 is in sheet form, and may be or include a support member such as a web, ribbon, tape, belt, film, card, or the like. In this regard, a sheet denotes an article having two large surface dimensions and a comparatively small thickness dimension, and in some cases, the sheet may be wound up to form a roll. In that regard the substrate 322 is typically thin and flexible, yet strong enough to withstand forces and tensions experienced in a coating machine, without undue breakage. The substrate 322 can be opaque, transparent, or translucent, and can be colored or uncolored. The substrate material can be fibrous including, for example, paper and filamentous synthetic materials. It can be a film including, for example, cellophane and synthetic polymeric sheets cast, extruded, or otherwise formed. Suitable plastic films include films of polypropylene (including oriented polypropylene (OPP) and biaxially oriented polypropylene (BOPP)), polyethylene (PE), and polyethylene terephthalate (PET). The substrate material can thus be non-cellulosic. A typical substrate 322 may be or include a neutral sized base paper. The thickness of the substrate 322 may depend on its composition, but a typical thickness (caliper) range for cellulosic materials is from 1.9 to 12 mils (e.g. 50 to 300 μm), or other suitable thicknesses.

The thermal insulating layer 324 may be applied directly to the surface 322a of the substrate 322 before other coatings are applied. The thermal insulating layer 324 may in some cases be characterized or described as a separator layer, heat-reflective layer, isolation layer, prime coat, or basecoat. The layer 324 may provide a degree of thermal insulation between the thermally responsive layer 326 and the substrate 322. Such thermal insulation promotes image quality, imaging speed, or both, by ensuring that heat delivered by the thermal print head is not substantially lost by thermal conduction from the thermally responsive layer to the more massive substrate 322. The thermal conductivity of the layer 324 is thus preferably less than both the thermal conductivity of the thermally responsive layer 326, and the thermal conductivity of the substrate 322.

The thermal insulating layer 324 may comprise hollow sphere pigments (HSP) and/or other fillers such as calcined clay, ground calcium carbonate, precipitated calcium carbonate, and plastic pigments other than HSP. The HSP may have any suitable average particle size, for example, 0.4 μm to 2.0 μm. The layer 324 may also include binders, e.g., latexes such as styrene-butadiene rubber (SBR), and acrylics or starches, or polyvinyl alcohol (PVOH). The layer 324 may further include additives such as defoamers, dispersants, and optical brighteners. This list of fillers, binders, and additives should not be considered as limiting or all-encompassing.

The thermal insulating layer 324 can be made by a process in which a dispersion is coated onto the surface 322a of the substrate, and then dried. Other coatings discussed herein may be made by similar processes. The coatings can be made individually, one layer at a time, or collectively, such as by the use of a 2-layer slot die or a curtain coater. In some cases, the thermal insulating layer 324 may be eliminated and omitted from the product construction. When included as part of the recording material, the thermal insulating layer may be applied in any suitable thickness, e.g. at a coat weight from 2.5 to 7.5 pounds/3,300 ft² (3.7 to 11 g/m²), for a finished dry thickness in a range from 10 to 30 μm, or other suitable thicknesses.

The thermally responsive layer 326 may alternatively be referred to as a heat-sensitive color-forming layer. This layer 326 comprises a color-forming composition that is thermally sensitive, i.e., it changes color upon sufficient heating. The color-forming composition has two main components: a color-forming dye (electron-donating dye precursor), also known as a leuco dye or chromogenic material, and an acidic developer. The leuco dye and acidic developer are usually dispersed in a binder. Sufficient heating will permit, the acidic developer to react with the leuco dye which results in the formation of a color at the site of the heating. Representative systems and materials are described in U.S. Pat. No. 3,539,375 (Baum), U.S. Pat. No. 3,674,535 (Blose et al.), U.S. Pat. No. 3,746,675 (Blose et al.), U.S. Pat. No. 4,151,748 (Baum), U.S. Pat. No. 4,181,771 (Hans on et al.), U.S. Pat. No. 4,246,318 (Baum), U.S. Pat. No. 4,470,057 (Glanz), and U.S. Pat. No. 5,955,398 (Fisher et al.).

In addition to the leuco dye and the developer, the color-forming composition of the layer 326 may also contain one or more materials referred to as modifiers, which aid in color formation. The modifier(s) can function by one or both of (a) lowering the melting point of the dye/developer, and (b) acting as a type of solvent in which the dye and developer dissolve or melt. The modifier(s) may thus facilitate the reaction between the leuco dye and the developer to produce a more intense thermal image, faster imaging, or both. See, for example, U.S. Pat. No. 4,531,140 (Suzuki et al.), U.S. Pat. No. 4,794,102 (Petersen et al.), U.S. Pat. No. 5,098,882 (Teraji et al.), U.S. Pat. No. 6,835,691 (Mathiaparanam et al.), and U.S. Pat. No. 6,921,740 (Hizatate et al.). The thermally responsive layer 326 may be applied in any suitable thickness, e.g. at a coat weight from 1.5 to 6 pounds/3,300 ft² (2.2 to 9 g/m²), or more preferably from 2-4 pounds/3,300 ft² (3 to 6 g/m²), for a finished dry thickness in a range from 1.2 to 4.8 μm, or from 1 to 5 μm, or other suitable thicknesses.

The topcoat 328 is a coating that serves as a vehicle to accept user-applied Memjet-type dye-based inks. The topcoat 328 may also function as a barrier to protect the thermally responsive layer 326 from chemical and environmental elements. The topcoat 328 is, however, not opaque, and it allows thermally-induced color portions of the layer 326 to be viewed by users of the recording material 320 through the surface 328a. The topcoat 328 may comprise fillers, such as precipitated silica, fumed silica, hydrated alumina, fumed alumina, aluminum trihydroxide. (ATH) of various particle sizes, etc., and hinders such as PVOH (fully hydrolyzed or partially hydrolyzed), lattices, especially lattices designed to be stable in a cationic environment, and other additives such as surfactants, crosslinkers, dispersants, defoamers, lubricants, optical brightners, and fixatives. Fixatives may serve to anchor the proprietary dye-based aqueous Memjet-type inks to the topcoat 328. Suitable fixatives may include but are not limited to, for example, polyamine solution polymers, which are water soluble cationic polymers. A polyamine solution polymer of particular applicability to the disclosed embodiments is sold under the tradename Catiofast 159A from BASF Corp., Florham Park, N.J. A representative chemical depiction of Catiofast 159A is reported in U.S. Pat. No. 8,562,126 (Xiang et al.), and is reproduced below. Other suitable fixatives may include: Catiofast 160, sold by BASF Corp.; Cartafix VXZ Liq 050, sold by Clariant Corp., Charlotte, N.C.; polydiallyl dimethyl ammonium chloride (polyDADMAC); and quaternary ammonium salts.

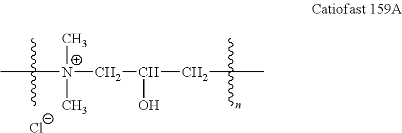

The foregoing components and ingredients for the topcoat 328 should not be considered as limiting or all-encompassing. Ultimately, the composition, thickness, and other relevant properties of the topcoat 328 are selected to ensure the topcoat is receptive to Memjet-type dye-based printing. In this regard the topcoat adequately anchors Memjet-type dye-based inks that are applied to it to avoid smearing, promotes fast drying, provides water fastness and permanence, and substantially maintains such inks at or near the outer surface of the topcoat (rather than allowing them to migrate deeper into the coating or other structure) to maintain excellent color vibrancy. Receptivity to Memjet-type dye-based printing may thus be characterized by a combination of no significant smearing and good or excellent color vibrancy of Memjet-type dye-based inks that are applied to the surface.

The topcoat 328 may be applied in any suitable thickness, e.g. at a coat weight from 1 to 6 pounds/3,300 ft² (1.5 to 9 g/m²), and more preferably less than 4 pounds/3,300 ft² (6 g/m²), for a finished dry thickness in a range from 0.9 to 5.4 μm, or from 1 to 5 μm, or other suitable thicknesses.

It was mentioned above that Memjet-type printing is different enough from other types of inkjet-type printing that a practical distinction must be made between the two. This is particularly true with regard to the topcoat 328. Thus, a topcoat 328 that is receptive to Memjet-type dye-based printing may not be receptive to standard inkjet printing. Likewise, a topcoat designed to be receptive to standard inkjet printing may not be receptive to Memjet-type printing. This is discussed and demonstrated further below.

Other coatings, including an optional backcoat, may be applied to the opposite side of the substrate 322, to the major surface 322b shown in FIG. 3. If a backcoat is included, it may be for adapted for printing, dimensional stability, barrier, adhesion, or the like, and may comprise any suitable materials. In some cases the backcoat may be the same as or similar to the topcoat 328, such that Memjet-type dye-based inks can also be printed onto the backcoat. That is, the backcoat may make the product suitable for double-sided printing by Memjet-type dye-based inks. Symmetrical embodiments can also be made, in which counterparts to layers 324, 326, 328 are provided on surface 322b. The disclosed recording materials may readily be used as labels by applying a pressure sensitive adhesive layer, or other adhesive layer(s), to the back side (major surface 322b ) of the substrate, optionally also with a release liner to cover the adhesive layer.

In preferred embodiments, the thermally responsive layer 326 contains no, or substantially no (e.g. no effective amount, or not more than trace amounts) of isocyanate. Furthermore, the entire thermal recording material 320 is likewise preferably isocyanate free, or at least substantially isocyanate free (i.e., measurable, but only at insignificant trace amounts). Isocyanates are disfavored in some environments, and can even be hazardous.

As mentioned above, in the course of our work we discovered a significant and surprising interaction between Memjet-type dye-based inks (when applied to the topcoat 328) and the thermally responsive layer 326, despite the fact that the topcoat 328 itself separates the ink from the thermally responsive layer. The interaction manifests itself as a discoloration as follows: within a short time after printing the Memjet-type dye-based inks onto the topcoat 328, a darkening or graying of one of the three primary ink colors namely, yellow becomes readily noticeable, rendering the printed color image less vibrant. The discoloration is distinctly different from a fading phenomenon of the ink, and the discoloration occurs in the absence of any thermal imaging of the underlying thermally responsive layer 326. That is to say, the darkening of the Memjet-type dye-based inks occurs even when the underlying thermally responsive layer is in its original condition before any thermal-induced color change. tf, however, the thermally responsive layer 326 is entirely omitted from the construction, no discoloration occurs. A recording material that suffers from the above discoloration problem can nevertheless be said to have a topcoat that is receptive to Memjet-type dye-based printing, provided the topcoat otherwise has good anti-smear, drying, and color vibrancy characteristics of the printed inks as discussed above.

Fortunately, we have also discovered that by careful selection of the composition of the thermally responsive layer 326, discoloration (graying) of the Memjet-type dye-based ink can be substantially avoided, while also avoiding smearing problems, and maintaining the functionality of the thermally responsive layer. Thus, a direct thermal product that is also compatible with Memjet-type printing technology can be achieved.

More specifically, we have found that the discoloration or graying problem described above can be solved by careful selection of the leuco dye/acidic developer combination used in the thermally responsive layer 326. We have come to this conclusion after fabricating and testing numerous embodiments of dual functionality recording materials, which are described further below.

We investigated a number of sulfone-based developers, including the following.

| Formula no. | CAS no. | Chemical name | Referred to herein as |
|---|---|---|---|
| 1 | 80-09-1 | 4,4′-Dihydroxydiphenylsulfone | 4,4′-BPS |
| 2 | 5397-34-2 | 2,4′-Dihydroxydiphenylsulfone | 2,4′-BPS |
| 3 | 41481-66-7 | Bis(3-allyl-4-hydroxyphenyl)sulfone | TGSH |
| 4 | 95235-30-6 | 4-Hydroxy-4′-isopropoxydiphenylsulfone | D8 |
| 5 | 95235-30-6 | 4-Hydroxy-4′-benzyloxydiphenylsulfone | BPS-MBE |
| 6 | 97042-18-7 | 4-Hydroxy-4′-allyloxydiphenylsulfone | BPS-MAE |
| 7 | 80-08-0 | 4,4′-Diaminodiphenylsulfone | 4,4′-DDS |
| 8 | 599-61-1 | 3,3′-Diaminodiphenylsulfone | 3,3′-DDS |
| 9 | 64-77-7 | 1-butyl-3-(4-methylphenyl)sulfonylurea | Tolbutamide |
| 10 | 232938-43-1 | 3-(3-Tosylureido)phenyl p-toluenesulfonate | Pergafast 201 |

The formula numbers in the above table are depicted below.

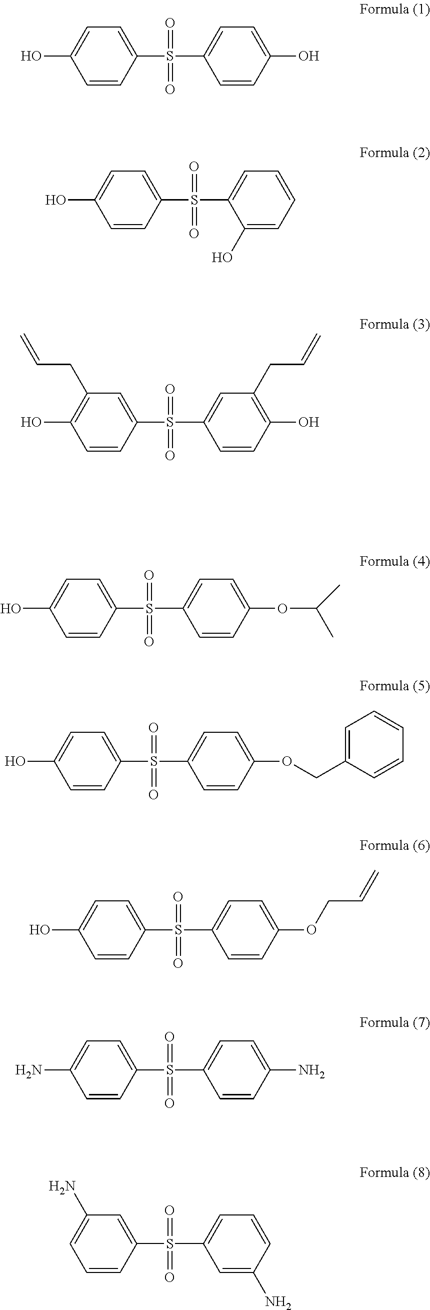

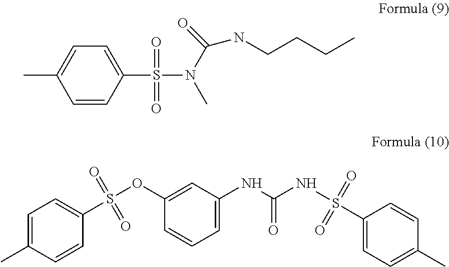

Among these materials, BPS (both 4,4′ and 2,4′) and TGSHare bis-phenolic, D8, BPS-MBE, and BPS-MAE are mono-phenolic, and DDS (both 4,4′ and 3,3′), Tolbutamide, and Pergafast 201 are non-phenolic. Related materials of the foregoing developers, including isomers thereof, are also contemplated.

Our investigation also encompassed a number of fluoran-based leuco dyes, including the following:

| Formula no. | CAS no. | Chemical name | Referred to herein as |
|---|---|---|---|
| 11 | 129473-78-5 | spiro(isobenzofuran-1(3H),9′-(9H)xanthen- | BK305 |
| | | 3-one, 6′-(dipentylamino)-3′-methyl-2′- | |
| | | (phenylamino)- | |
| 12 | 59129-79-2 | spiro(isobenzofuran-1(3H),9′-(9H)xanthen)- | ETAC |
| | | 3-one, 6′-(ethyl(4-methylphenyl)amino)-3′- | |
| | | methyl-2′-(phenylamino)- | |
| 13 | 89331-94-2 | spiro(isobenzofuran-1(3H),9′-(9H)xanthen)- | ODB-2 |
| | | 3-one, 6′-(ethyl(4-methylphenyl)amino)-3′- | |
| | | methyl-2′-(phenylamino)- | |

The formula numbers in the above table are depicted below.

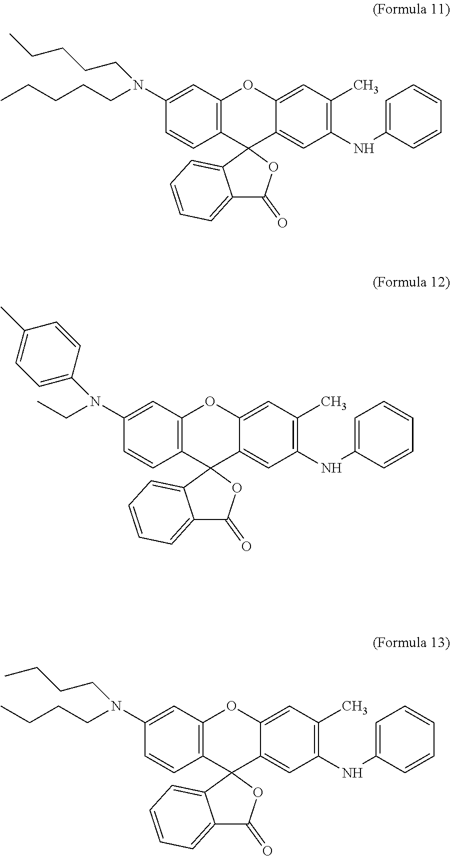 [SMILES: CCCCCN(CCCCC)c1ccc2c(c1)Oc1cc(C)c(Nc3ccccc3)cc1C21OC(=O)c2ccccc21 ; CCN(c1ccc(C)cc1)c1ccc2c(c1)Oc1cc(C)c(Nc3ccccc3)cc1C21OC(=O)c2ccccc21 ; CCCCN(CCCC)c1ccc2c(c1)Oc1cc(C)c(Nc3ccccc3)cc1C21OC(=O)c2ccccc21]

These leuco dyes are instances of fluoran compounds of the type shown in Formula 14 below, where R1 is a hydrogen or alkyl, where R2 is hydrogen or alkaryl, where R3 is aryl when R2 is hydrogen, or alkaryl when R2 is alkaryl, where R4 and R5 are each independently selected from alkyl aralkyl, or R4 and R5 form a four carbon ring pyrrolidine structure.

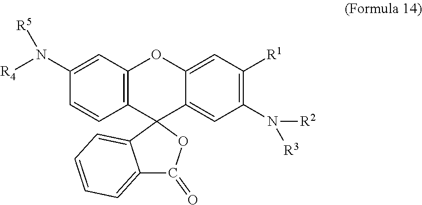

Our investigation also encompassed a number of modifiers, including the following: dimethyldiphenoxyethane, referred to as “DME”;
1,2-diphenoxyethane, referred to as “DPE”;
diphenyl sulfone, referred to as “DPS”; and
stearamide wax, namely a fatty acid amide of the type shown in Formula 15 below.

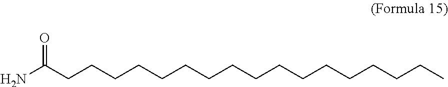 [SMILES: CCCCCCCCCCCCCCCCCC(N)=O]

The stearamide wax is an instance of a fatty acid amide of the type shown in Formulas 16 or 17, where m is 1 to 23, and n is 0 to 21.

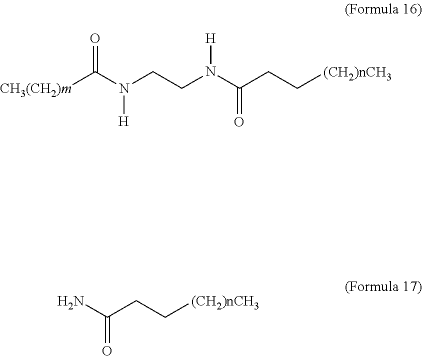

Our investigation revealed that the above-described discoloration problem of the Memjet-type dye-based ink occurs in embodiments wherein: the developer belongs to the class of sulfone developers and more specifically, a bis-phenol based sulfone developer such as BPS or TGSH; and the leuco dye is ODB-2 or BK305; and the modifier is any of the listed modifiers, or where the modifier is omitted. However, the discoloration problem does not substantially occur, and the Memjet-type ink colors remain vibrant, when either of the foregoing bis-phenolic developers are instead combined with the leuco dye ETAC, regardless of which modifier (including no modifier) is used.

We also found that the discoloration problem does not substantially occur in embodiments wherein a mono-phenol based sulfone developer, specifically, D8 or MBE, is combined with any of the listed leuco dyes, regardless of which modifier (including no modifier) is used. Similarly, the discoloration problem does not substantially occur in embodiments wherein a non-phenolic developer, specifically, DDS (combined with Tolbutamide), is combined with any of the listed leuco dyes.

### EXAMPLES AND COMPARATIVE EXAMPLES

In accordance with the foregoing teachings, we prepared and tested a number of dual functionality recording media, and other samples (comparative examples) as described. These tests are illustrative of the invention and should not he considered as unduly limiting.

The substrate (see item 322 in FIG. 3) that was used as the basis for the various samples was a 63 g/m² high brightness base paper stock with a thickness of 76.2±7.6 micrometers. To this substrate was then applied a series of coatings to form the various distinct layers described above in connection with FIG, 3, namely, the thermal insulating layer 324, the thermally responsive layer 326, and the topcoat 328.

Dispersions of particular system components were prepared and combined in different proportions to yield the desired coating formulations for each coating. A dispersion of a given component was prepared by milling the component in an aqueous solution of the binder until a particle size of less than 10 micrometers was achieved. Milling was carried out in an attritor or other suitable milling device. The desired average particle size was less than 3 microns in each dispersion.

In a first coating step, a first coating formulation was prepared and coated onto one major surface of the substrate to form a thermal insulating layer. Next, after this coating was dried, a second coating was applied atop the thermal insulating layer to form a thermally responsive layer. Finally, after drying, a third coating was applied atop the thermally responsive layer to form a topcoat, to provide receptivity to Memjet-type dye-based printing.

Samples were tested by subjecting each sample to Memjet-type dye-based printing in the absence of any direct thermal imaging. This was done using a Memjet™ C6010 printer. Upon feeding the sample into the printer, the printer carried out its function of depositing the Memjet™ dye-based inks onto the surface of the topcoat in a test pattern that included non-overlapping patches of yellow, magenta, cyan, and black ink, each patch being formed by depositing ink from only one of the printer's primary color reservoirs (Y, M, C, or black, not mixtures thereof). The print speed was 12 inches per second. The printed ink pattern was evaluated to determine if the exposed surface of the sample was receptive to Memjet-type dye-based printing.

Discoloration (graying) of the yellow ink patch immediately after printing was particularly noticeable on some of the samples. To quantify this effect, a Gretag™ densitometer was employed to measure the black optical density component (D_{B}) of the yellow ink patch. A baseline or benchmark was established for this parameter by fabricating a baseline sample that omitted the thermal insulating layer and the thermally responsive layer (i.e., the baseline sample was made simply by forming the topcoat directly on the surface of the substrate). The measured black optical density component (D_{B}) of the yellow ink patch that was printed onto the topcoat of the baseline sample then served as a reference point from which D_{B} measurements from other samples could be compared.

Samples (other than the baseline sample) were also tested for their direct thermal imaging performance. In that regard, a barcode pattern was imaged, at a location on the sample devoid of any Memjet-type inks, by direct thermal imaging using an Atlantek™ Model 400 test system at medium energy setting. The quality of the barcode image was then assessed using a TRUCHECK™ verifier at 650 nm. This device provides a barcode quality measurement in accordance with the ANSI (American National Standards Institute)) “Barcode Print Quality Guideline”, X3.182 (1990). The output of the ANSI method is a grade for any barcode on a scale of 0.0 to 4.0, where a value less than 0.5 is assigned a letter grade of “F”, a value from 0.5 to less than 1.5 is assigned a letter grade “D”, a value from 1.5 to less than 2.5 is assigned a letter grade “C”, a value from 2.5 to less than 3.5 is assigned a letter grade “B”, and a value from 3.5 to 4.0 is assigned letter grade “A”. A bar code with a letter grade “C” or better (ANSI value of at least 1.5) generally scans on a first pass with properly maintained scanners, and may be considered passing for purposes of our direct thermal imaging performance tests.

The various coating formulations, dispersions, etc. will now be described, followed by a table showing the makeup of the various samples and the results of the testing. In the description below, all parts or proportions are by weight, and all measurements are in the metric system, unless otherwise specified.

Dispersion A1 (Leuco Dye)

| Material | Parts |
|---|---|
| ETAC chromogenic material (leuco dye) | 34.0 |
| binder, 20% solution of polyvinyl alcohol in water | 20.0 |
| dispersing and defoaming agents | 0.4 |
| Water | 38.6 |

Dispersion A1 was made as set forth above, using ETAC as the leuco dye. Another dispersion, referred to as Dispersion A2, was the same as Dispersion A1 except that ODB-2 was used in place of ETAC for the leuco dye. Still another dispersion, referred to as Dispersion A3, was the same as Dispersion A1 except that BK305 was used in place of ETAC for the leuco dye,

Dispersion B1 (Developer)

| Material | Parts |
|---|---|
| 4,4′-BPS acidic developer material | 39.0 |
| binder, 20% solution of polyvinyl alcohol in water | 24.0 |
| dispersing and defoaming agents | 0.5 |
| Water | 36.5 |

Dispersion B1 was made as set forth above, using 4,4′-BPS as the developer. Another dispersion, referred to as Dispersion B2, was the same as Dispersion B1 except that D8 was used in place of 4,4′-BPS for the developer. Another dispersion, referred to as Dispersion B3, was the same as Dispersion B1 except that BPS-MBE was used in place of 4,4′-BPS for the developer. Still another dispersion, referred to as Dispersion B4, was the same as Dispersion B1 except that TGSH was used in place of 4,4′-BPS for the developer. Another dispersion, referred to as Dispersion B5, was the same as Dispersion B1 except that 4,4′-DDS combined with Tolbutamide (in equal amounts) was used in place of 4,4′-BPS for the developer. (Instead of combining the DDS and Tolbutamide in one dispersion, separate dispersions of DDS and Tolbutamide can also be used.) Still another dispersion, referred to as Dispersion B6, was the same as Dispersion B1 except that Pergafast201 was used in place of 4,4′-BPS for the developer.

Dispersion C1 (Modifier)

| Material | Parts |
|---|---|
| DPE modifier material | 25.0 |
| binder, 20% solution of polyvinyl alcohol in water | 20.0 |
| dispersing and defoaming agents | 1.0 |
| Water | 54.0 |

Dispersion C1 was made as set forth above, using DPE as the modifier. Another dispersion, referred to as Dispersion C2, was the same as Dispersion C1 except that DPS was used in place of DPE for the modifier. Another dispersion, referred to as Dispersion C3, was the same as Dispersion C1 except that DME was used in place of DPE for the modifier. Still another dispersion, referred to as Dispersion C4, was the same as Dispersion C1 except that Stearamide wax was used in place of DPE for the modifier.

Coating formulations were prepared as follows:

Coating Formulation - Thermal Insulating Layer

| Material | Parts |
|---|---|
| Filler | 47 |
| Latex | 12 |
| Dispersing and wetting agents | 1 |
| Water | 40 |

For each of Examples 2-66, the above coating formulation was used to form the thermal insulating layer(see layer 324 in FIG. 3). The coating was applied at a weight of coat of 3.5 pounds/3,300 ft² (5.2 g/m²).

Coating Formulation I - Thermally
Responsive Layer (without Modifier)

| Material | Parts |
|---|---|
| Dispersion A (A1 or A2 or A3) | 26.5 |
| Dispersion B (B1 or B2 or B3 or B4 or B5 or B6) | 49.0 |
| binder - SBR latex (50% solids) | 4.8 |
| binder, 8% solution of PVOH | 4.2 |
| filler slurry (70% in water) | 5.4 |
| Water | 10.1 |

Coating Formulation II - Thermally Responsive Layer (with Modifier)

| Material | Parts |
|---|---|
| Dispersion A (A1 or A2 or A3) | 20.0 |
| Dispersion B (B1 or B2 or B3 or B4) | 37.0 |
| Dispersion C (C1 or C2 or C3 or C4) | 20.0 |
| binder - SBR latex (50% solids) | 3.9 |
| binder, 8% solution of PVOH | 4.5 |
| filler slurry (70% in water) | 5.1 |
| Water | 9.5 |

For each of Examples 2-66, either Coating Formulation I (without modifier), or Coating Formulation II (with modifier), was used to form the thermally responsive layer (see layer 326 in FIG. 3). In both cases, the coating was applied at a weight of coat of 3.0 pounds/3,300 ft² (4.4 g/m²).

Coating Fommiation - Topcoat

| Material | Parts |
|---|---|
| alumina trihydrate slurry (39% in water) | 33.3 |
| silica slurry (30% in water) | 7.7 |
| binder, 9% solution of PVOH | 30.9 |
| fixative (50% solids) | 4.6 |
| additives (cross linker) | 9.3 |
| additive (lubricant and dispersant) | 3.5 |
| Water | 10.7 |

For each of Examples 1-66, the above coating formulation was used to form the topcoat, which is formulated to be receptive to Memjet-type dye-based printing. In the case of Example 1, the topcoat was formed directly on the substrate. For the other examples, the topcoat was formed atop the thermally responsive layer, as shown by layer 328 in FIG. 3. In both cases, the coating was applied at a weight of coat of 3.0 pounds/3,300 ft² (4.4 g/m²).

Examples 1 through 66 were then fabricated as shown in the tables below. Their performance is also reported in the tables. Example 1 is the baseline sample discussed above, hence, it contains no thermal insulating layer and no thermally responsive layer. The remaining examples, Examples 2-66, contain all the layers shown in FIG. 3. In the tables, the “Coating Formulation (I or II)” column refers to the coating formulation used for the thermally responsive layer. The particular dispersions used (A1, A2, or A3, and B1, B2, B3, B4, B5, or B6, and C1, C2, C3, or C4) in that coating formulation are indicated under the columns “Developer”, “Modifier”, and “Leuco dye”. For instance, Example 14 used Coating Formulation II, with Dispersions A1 (ETAC), B1 (4,4′-BPS), and C1 (DPE). The “Yellow DB value” in the tables refers to the black optical density component (D_{B}) of the yellow ink patch as measured by the Gretag™ densitometer, discussed above. The “ANSI value” refers to the quality measurement of the thermally imaged barcode pattern as measured by the TRUCHECK™ verifier, as discussed above.

### Examples 1-13

| | Coating | | | | Yellow | |
|---|---|---|---|---|---|---|
| Exam- | Formulation | Devel- | | Leuco | DB | ANSI |
| ple | (I or II) | oper | Modifier | dye | value | value |
| 1 | n/a | n/a | n/a | n/a | 0.057 | n/a |
| 2 | I | D8 | n/a | ETAC | 0.063 | 3.0 |
| 3 | I | D8 | n/a | ODB-2 | 0.066 | 3.1 |
| 4 | I | D8 | n/a | BK305 | 0.074 | 3.2 |
| 5 | I | TGSH | n/a | ETAC | 0.074 | 3.1 |
| 6* | I | TGSH | n/a | ODB-2 | 0.120 | 3.1 |
| 7* | I | TGSH | n/a | BK305 | 0.140 | 3.4 |
| 8 | I | BPS-MBE | n/a | ETAC | 0.063 | 3.1 |
| 9 | I | BPS-MBE | n/a | ODB-2 | 0.066 | 3.3 |
| 10 | I | BPS-MBE | n/a | BK305 | 0.072 | 3.1 |
| 11 | I | 4,4′-BPS | n/a | ETAC | 0.074 | 2.6 |
| 12* | I | 4,4′-BPS | n/a | ODB-2 | 0.113 | 3.0 |
| 13* | I | 4,4′-BPS | n/a | BK305 | 0.112 | 3.3 |

### Examples 14-25

| | Coating | | | | Yellow | |
|---|---|---|---|---|---|---|
| Exam- | Formulation | Devel- | | Leuco | DB | ANSI |
| ple | (I or II) | oper | Modifier | dye | value | value |
| 14 | II | 4,4′-BPS | DPE | ETAC | 0.077 | 3.0 |
| 15* | II | 4,4′-BPS | DPE | ODB-2 | 0.111 | 3.2 |
| 16* | II | 4,4′-BPS | DPE | BK305 | 0.111 | 3.3 |
| 17 | II | 4,4′-BPS | DPS | ETAC | 0.081 | 3.4 |
| 18* | II | 4,4′-BPS | DPS | ODB-2 | 0.112 | 3.5 |
| 19* | II | 4,4′-BPS | DPS | BK305 | 0.122 | 3.3 |
| 20 | II | 4,4′-BPS | DME | ETAC | 0.075 | 2.8 |
| 21* | II | 4,4′-BPS | DME | ODB-2 | 0.110 | 3.3 |
| 22* | II | 4,4′-BPS | DME | BK305 | 0.110 | 3.2 |
| 23 | II | 4,4′-BPS | Wax | ETAC | 0.077 | 3.2 |
| 24* | II | 4,4′-BPS | Wax | ODB-2 | 0.108 | 3.5 |
| 25* | II | 4,4′-BPS | Wax | BK305 | 0.099 | 3.4 |

### Examples 26-37

| | Coating | | | | Yellow | |
|---|---|---|---|---|---|---|
| Exam- | Formulation | Devel- | | Leuco | DB | ANSI |
| ple | (I or II) | oper | Modifier | dye | value | value |
| 26 | II | D8 | DPE | ETAC | 0.068 | 3.3 |
| 27 | II | D8 | DPE | ODB-2 | 0.068 | 3.2 |
| 28 | II | D8 | DPE | BK305 | 0.070 | 3.0 |
| 29 | II | D8 | DPS | ETAC | 0.069 | 3.2 |
| 30 | II | D8 | DPS | ODB-2 | 0.070 | 3.3 |
| 31 | II | D8 | DPS | BK305 | 0.072 | 3.2 |
| 32 | II | D8 | DME | ETAC | 0.070 | 3.2 |
| 33 | II | D8 | DME | ODB-2 | 0.067 | 3.1 |
| 34 | II | D8 | DME | BK305 | 0.071 | 3.3 |
| 35 | II | D8 | Wax | ETAC | 0.066 | 3.2 |
| 36 | II | D8 | Wax | ODB-2 | 0.068 | 3.3 |
| 37 | II | D8 | Wax | BK305 | 0.069 | 3.5 |

### Examples 38-49

| | Coating | | | | Yellow | |
|---|---|---|---|---|---|---|
| Exam- | Formulation | Devel- | | Leuco | DB | ANSI |
| ple | (I or II) | oper | Modifier | dye | value | value |
| 38 | II | BPS-MBE | DPE | ETAC | 0.068 | 3.3 |
| 39 | II | BPS-MBE | DPE | ODB-2 | 0.072 | 3.2 |
| 40 | II | BPS-MBE | DPE | BK305 | 0.068 | 3.2 |
| 41 | II | BPS-MBE | DPS | ETAC | 0.070 | 3.4 |
| 42 | II | BPS-MBE | DPS | ODB-2 | 0.071 | 3.2 |
| 43 | II | BPS-MBE | DPS | BK305 | 0.071 | 3.0 |
| 44 | II | BPS-MBE | DME | ETAC | 0.069 | 3.3 |
| 45 | II | BPS-MBE | DME | ODB-2 | 0.069 | 3.3 |
| 46 | II | BPS-MBE | DME | BK305 | 0.072 | 3.4 |
| 47 | II | BPS-MBE | Wax | ETAC | 0.069 | 3.3 |
| 48 | II | BPS-MBE | Wax | ODB-2 | 0.068 | 3.2 |
| 49 | II | BPS-MBE | Wax | BK305 | 0.071 | 3.4 |

### Examples 50-66

| | Coating | | | | Yellow | |
|---|---|---|---|---|---|---|
| Exam- | Formulation | Devel- | | Leuco | DB | ANSI |
| ple | (I or II) | oper | Modifier | dye | value | value |
| 50 | II | TGSH | DPE | ETAC | 0.078 | 3.4 |
| 51* | II | TGSH | DPE | ODB-2 | 0.123 | 3.0 |
| 52* | II | TGSH | DPE | BK305 | 0.125 | 2.9 |
| 53 | II | TGSH | DPS | ETAC | 0.077 | 3.3 |
| 54* | II | TGSH | DPS | ODB-2 | 0.133 | 3.1 |
| 55* | II | TGSH | DPS | BK305 | 0.133 | 3.2 |
| 56 | II | TGSH | DME | ETAC | 0.075 | 3.5 |
| 57* | II | TGSH | DME | ODB-2 | 0.100 | 3.3 |
| 58* | II | TGSH | DME | BK305 | 0.102 | 3.1 |
| 59 | II | TGSH | Wax | ETAC | 0.074 | 3.6 |
| 60* | II | TGSH | Wax | ODB-2 | 0.098 | 3.4 |
| 61* | II | TGSH | Wax | BK305 | 0.099 | 3.5 |
| 62 | II | DDS (+T) | n/a | ETAC | 0.077 | 2.3 |
| 63 | II | DDS (+T) | n/a | ODB-2 | 0.077 | 3.0 |
| 64 | II | DDS (+T) | n/a | BK305 | 0.077 | 3.1 |
| 65 | I | Pergafast | n/a | ODB-2 | 0.083 | 3.0 |
| | | 201 | | | | |
| 66 | I | Pergafast | n/a | ETAC | 0.080 | 3.0 |
| | | 201 | | | | |

In Examples 62-64, “DDS (+T)” refers to 4,4′-DDS combined with Tolbutamide. Many of the examples exhibited excessive discoloration (graying or darkening) of the printed yellow ink patch, such that colors of the printed Memjet ink were noticeably less vibrant to the naked eye. Other examples exhibited little or no such discoloration, and maintained vibrant colors of the printed Memjet dye-based inks. We determined, based on visual appearance, that the threshold between excessive discoloration and little to no discoloration corresponds to a yellow D_{B} value of 0.098. Below 0.098, the discoloration is non-existent or minimal, but at or above 0.098 it is unacceptable. Examples that failed this condition (i.e., examples that exhibited excessive discoloration) are marked with an asterisk in the Example column in the above tables, and can be considered to be comparative examples. The remaining examples passed the discoloration condition, and maintained, or substantially maintained, fully vibrant colors of the printed Memjet dye-based inks,

None of Examples 1-66 exhibited any significant smearing of the printed Memjet inks; furthermore, all of the examples were determined to be receptive to Memjet-type dye-based printing. All of Examples 2-66 exhibited acceptable image quality of the direct thermal image (barcode) as reflected in the measured ANSI value, indeed, almost all values were a “B” rating or higher. All of the examples were isocyanate-free. Persons of ordinary skill in the art may readily repeat the results obtained above using embodiments in which the paper substrate is replaced with a film of polypropylene, polyethylene, or polyethylene terephthalate.

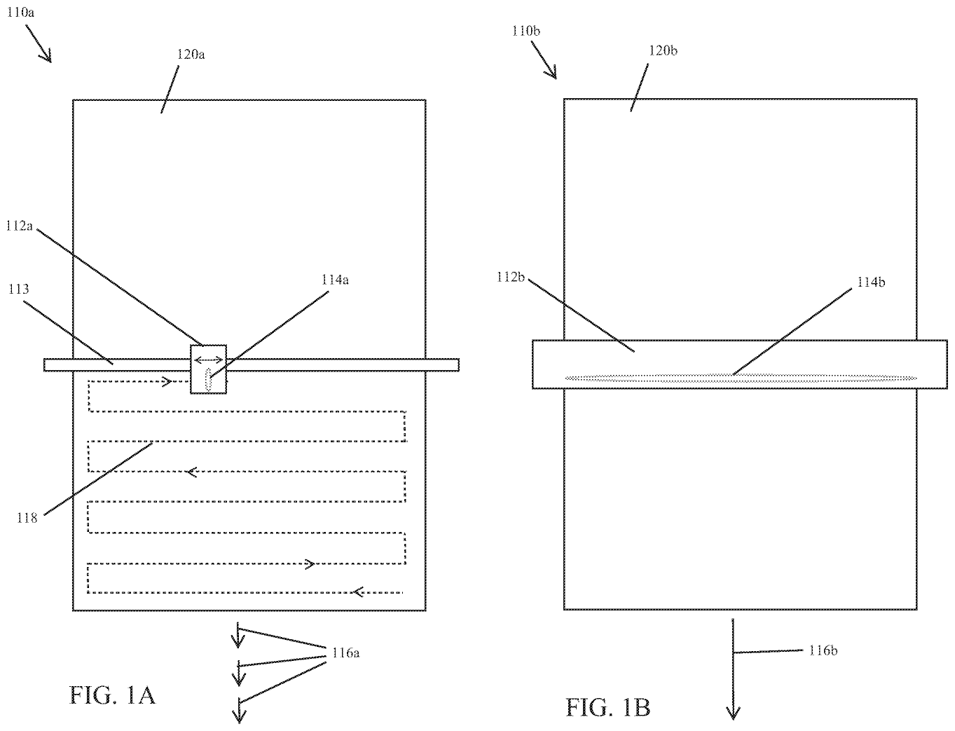

In addition to fabricating and testing the embodiments of Examples 1-66, we also performed testing to compare Memjet-type printing and standard inkjet printing (see e.g. FIGS. 1A and 1B above). In one test, we took a sample of Example 56, and printed onto it the same colorful test pattern used in the examples using, on the one hand, the same Memjet™ CP6010 printer used in the examples, and on the other hand, an Epson™ Stylusrm inkjet dye-based printer, which prints by conventional inkjet methodology. There was a very noticeable difference to the naked eye in the vibrancy and ink snap of the printed images, where “ink snap” refers to a combination of vibrancy and crispness of image and color. The image printed with the Memjet™ printer was colorful and vibrant, but the image printed with the conventional inkjet printer was substantially less vibrant and washed out, appearing as if (without wishing to be bound by theory) the inkjet inks overpenetrated the surface such that insufficient ink remained at the surface to produce a vibrant appearance. However, when the conventional inkjet printer was used to print the same image on a standard inkjet substrate (standard coated paper, with no thermally sensitive layers and direct thermal imaging capability), excellent color vibrancy and ink snap was obtained. This demonstrated that at least some layers or surfaces that are receptive to Memjet-type ink-based printing, including that of Example 56, are not receptive to conventional inkjet-type printing.

In summary, we have demonstrated thermally responsive record materials that can be thermally imaged and also digitally printed with Memjet-type dye-based printing technology, thus yielding a record material with exceptional direct thermal imaging and superb digital Memjet-type printing.

Unless otherwise indicated, all numbers expressing quantities, measured properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

The use of relational terms such as “top”, “bottom”, “upper”, “lower”, “above”, “below”, and the like to describe various embodiments are merely used for convenience to facilitate the description of some embodiments herein. Notwithstanding the use of such terms, the present disclosure should not be interpreted as being limited to any particular orientation or relative position, but rather should be understood to encompass embodiments having any orientations and relative positions, in addition to those described above.

Various modifications and alterations of this invention will be apparent to those skilled in the art without departing from the spirit and scope of this invention, which is not limited to the illustrative embodiments set forth herein. The reader should assume that features of one disclosed embodiment can also be applied to all other disclosed embodiments unless otherwise indicated. All U.S. patents, patent application publications, and other patent and non-patent documents referred to herein are incorporated by reference, to the extent they do not contradict the foregoing disclosure.

What is claimed is:

1. A recording material, comprising:
a substrate; and
a thermally responsive layer and a topcoat carried by the substrate, the thermally responsive layer being disposed between the substrate and the topcoat;
wherein the topcoat is receptive to Memjet-type dye-based printing;
wherein the thermally responsive layer includes a leuco dye and a developer; and
wherein at least one of the leuco dye and the developer is selected to substantially avoid graying of ink applied to the topcoat by Memjet-type dye-based printing.

2. The recording material of claim 1, further comprising:
a thermal insulating layer disposed between the substrate and the thermally responsive layer.

3. The recording material of claim 2, wherein the topcoat contacts the thermally responsive layer, and the thermally responsive layer contacts the thermal insulating layer.

4. The recording material of claim 3, wherein the thermal insulating layer contacts the substrate.

5. The recording material of claim 1, wherein the thermally responsive layer is substantially isocyanate-free.

6. The recording material of claim 1, wherein the developer is non-phenolic or mono-phenolic.

7. The recording material of claim 6, wherein the developer is non-phenolic and comprises 4,4′-DDS or 3,3′-DDS or Pergafast 201.

8. The recording material of claim 6, wherein the developer is mono-phenolic and comprises D8 or BPS-MBE.

9. The recording material of claim 1, wherein the developer is bis-phenolic.

10. The recording material of claim 9, wherein the developer comprises 4,4′-BPS or TGSH, and the leuco dye comprises ETAC.

11. The recording material of claim 1, wherein the topcoat comprises a filler, a binder, and a fixative.

12. The recording material of claim 11, wherein the filler comprises at least one of precipitated silica, fumed silica, hydrated alumina, fumed alumina, and aluminum trihydroxide (ATH).

13. The recording material of claim 11, wherein the binder comprises PVOH.

14. The recording material of claim 11, wherein the fixative comprises a polyamine solution polymer.

15. The recording material of claim 1, wherein the topcoat is not receptive to at least some inkjet-type printing.

16. The recording material of claim 1, wherein the substrate comprises one or more of an absorbent paper stock, polypropylene, polyethylene, or polyethylene terephthalate.

17. The recording material of claim 1, wherein the thermally responsive layer and the topcoat are substantially coextensive with the substrate.

18. The recording material of claim 1, wherein one or both of the thermally responsive layer and the topcoat are not coextensive with the substrate, such that some locations on the substrate are devoid of the thermally responsive layer, or of the topcoat, or of both.

19. A recording material, comprising:
a substrate; and
a thermal insulating layer, a thermally responsive layer, and a topcoat carried by the substrate, the thermally responsive layer being disposed between the thermal insulating layer and the topcoat, and the thermal insulating layer being disposed between the substrate and the thermally responsive layer;
wherein the topcoat is receptive to Memjet-type dye-based printing;
wherein the thermally responsive layer includes a leuco dye and a developer; and
wherein (a) the developer is non-phenolic, or (b) the developer is mono-phenolic, or (c) the developer is his-phenolic and the leuco dye comprises ETAC, such that (d) graying of Memjet-type dye-based inks printed onto the topcoat is substantially avoided.

20. The recording material of claim 19, wherein the thermally responsive layer is substantially isocyanate-free.

21. The recording material of claim 19, wherein the topcoat comprises a filler, a binder, and a fixative.

22. The recording material of claim 19, wherein the topcoat is not receptive to at least some inkjet-type printing.
